(19) United States
(12) Patent Application Publication
(10) Pub. No.: US 2026/0094454 A1
(43) Pub. Date: Apr. 2, 2026

(54) CLASSIFICATION DEVICE, CLASSIFICATION METHOD, AND NON-TRANSITORY RECORDING MEDIUM

(71) Applicant: PFU LIMITED, Ishikawa (JP)

(72) Inventors: Jian LI, Ishikawa (JP); Hiroki TANIZAKI, Ishikawa (JP); Yudai ASAI, Ishikawa (JP); Masanobu HONGO, Ishikawa (JP)

(21) Appl. No.: 19/324,588

(22) Filed: Sep. 10, 2025

(30) Foreign Application Priority Data
Sep. 27, 2024 (JP) 2024-168291

(51) Int. Cl. G06V 20/60; G06V 10/764; G06V 20/50

(52) U.S. Cl. CPC G06V 20/60; G06V 10/764; G06V 20/50

(57) ABSTRACT

A classification device includes circuitry to classify a type of a target bottle using a trained model trained with a plurality of bottle images. The plurality of bottle images includes a bottle image of a bottle that is a selection target and another bottle image of another bottle that is a foreign object excluded from selection. The circuitry determines whether the target bottle is the foreign object based on a classification result obtained by classifying the type of the target bottle.

### CROSS-REFERENCE TO RELATED APPLICATIONS

This patent application is based on and claims priority pursuant to 35 U.S.C. §119(a) to Japanese Patent Application No. 2024-168291, filed on September 27, 2024, in the Japan Patent Office, the entire disclosure of which is hereby incorporated by reference herein.

### BACKGROUND

The present disclosure relates to a classification device, a classification method, and a non-transitory recording medium.

At waste treatment facilities, large volumes of waste are conveyed daily on conveyor belts and subjected to processing. At waste processing sites, waste sorting is carried out manually by human workers. Although waste sorting is a relatively simple task, it imposes a significant physical burden on human workers. For this reason, a system that automatically performs waste sorting has been developed. Such a system may be referred to as a “waste sorting system.”

In a waste sorting system that performs tasks previously carried out by human workers in place of the human workers, each bottle conveyed on a belt conveyor is recognized, and based on the recognition result, a desired selection target such as one intended for recycling is picked up or selected from a stream or group of bottles conveyed on the belt conveyor using a robotic hand or a suction pad.

### SUMMARY

The classification device according to one aspect of the present disclosure includes circuitry to classify a type of a target bottle using a trained model trained with a plurality of bottle images. The plurality of bottle images includes a bottle image of a bottle that is a selection target and another bottle image of another bottle that is a foreign object excluded from selection. The circuitry determines whether the target bottle is the foreign object based on a classification result obtained by classifying the type of the target bottle.

The classification method according to another aspect of the present disclosure includes classifying a type of a target bottle using a trained model trained with a plurality of bottle images. The plurality of bottle images includes a bottle image of a bottle that is a selection target and another bottle image of another bottle that is a foreign object excluded from selection. The classification method includes determining whether the target bottle is the foreign object based on a classification result obtained by classifying the type of the target bottle.

The computer-readable, non-transitory medium according to still another aspect of the present disclosure stores a computer program. When the computer program is executed by one or more processors, the computer program causes the one or more processors to execute a process. The process includes classifying a type of a target bottle using a trained model trained with a plurality of bottle images. The plurality of bottle images includes a bottle image of a bottle that is a selection target and another bottle image of another bottle that is a foreign object excluded from selection. The process includes determining whether the target bottle is the foreign object based on a classification result obtained by classifying the type of the target bottle.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of a sorting system according to a first embodiment;

FIGS. 2A to 2G are diagrams illustrating specific examples of selection targets and foreign objects excluded from selection in the sorting system according to the first embodiment;

FIGS. 3A to 3D are diagrams illustrating examples of images to be used to increase the accuracy of classifying bottles in the sorting system according to the first embodiment;

FIG. 4 is a diagram illustrating a training process for a trained model used by a classification device according to the first embodiment;

FIGS. 5A and 5B are diagrams each illustrating an example of finer classification of types to be output by a trained model used by the classification device according to the first embodiment;

FIG. 6 is a block diagram illustrating a hardware configuration of the classification device according to the first embodiment;

FIG. 7 is a block diagram illustrating an example of a functional configuration of the sorting system according to the first embodiment;

FIG. 8 is a diagram illustrating an image used in an example of operation of an image processing unit of the classification device according to the first embodiment;

FIG. 9 is a diagram illustrating an image used in an example of operation of the image processing unit of the classification device according to the first embodiment;

FIG. 10 is a diagram illustrating an image used in an example of operation of the image processing unit of the classification device according to the first embodiment;

FIG. 11 is a diagram illustrating an image used in an example of operation of the image processing unit of the classification device according to the first embodiment;

FIG. 12 is a diagram illustrating an image used in an example of operation of the image processing unit of the classification device according to the first embodiment;

FIG. 13 is a diagram illustrating an image used in an example of operation of the image processing unit of the classification device according to the first embodiment;

FIG. 14 is a diagram illustrating an image used in an example of operation of the image processing unit of the classification device according to the first embodiment;

FIG. 15 is a diagram illustrating an image used in an example of operation of the image processing unit of the classification device according to the first embodiment;

FIG. 16 is a flowchart of an example of an operational flow of the classification device according to the first embodiment;

FIG. 17 is a diagram illustrating instance segmentation used by the classification device according to the first embodiment;

FIG. 18 is a diagram illustrating object detection used by the classification device according to the first embodiment;

FIG. 19 is a diagram illustrating an example of a bottle group image input to the classification device according to the first embodiment;

FIG. 20 is a diagram illustrating an operation of recognizing a contour performed by the classification device according to the first embodiment;

FIG. 21 is a diagram illustrating an operation of recognizing a bounding rectangle performed by the classification device according to the first embodiment;

FIG. 22 is a diagram illustrating an operation of calculating contour centroid coordinates performed by the classification device according to the first embodiment;

FIG. 23 is a diagram illustrating an example display presenting a type classification result from the classification device according to the first embodiment;

FIG. 24 is a diagram illustrating an example display presenting a determination result indicating whether a bottle is a foreign object from the classification device according to the first embodiment;

FIG. 25 is a diagram illustrating an example display presenting text information indicating a classification result and a determination result from the classification device according to the first embodiment; and

FIG. 26 is a flowchart of an example of an operational flow of the classification device according to a second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of a classification device, a classification method, and a program disclosed in the present application are described below in detail with reference to the drawings. The technology of the present disclosure, however, is not limited to the following description, and the elements in the following description include elements that may be easily conceived by those skilled in the art, elements being substantially the same, and elements being within the range of equivalency. Various omissions, substitutions, changes, and combinations of the elements may be made without departing from the gist of the following embodiments.

### First Embodiment

### Overview of Configuration and Operation of Sorting System

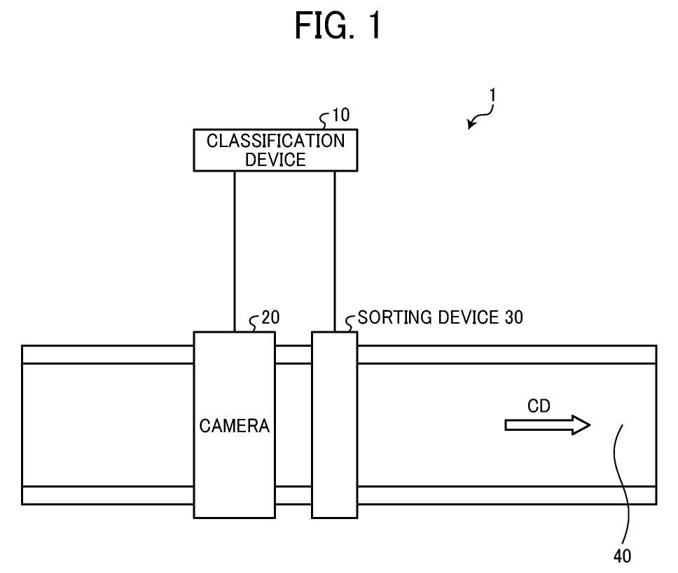

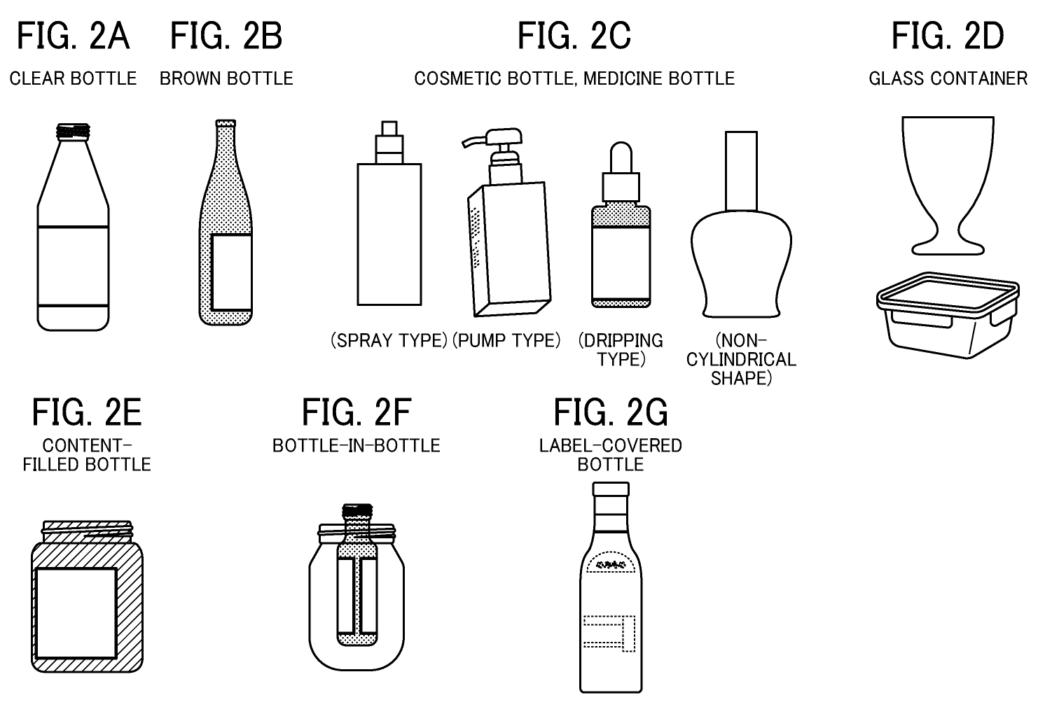

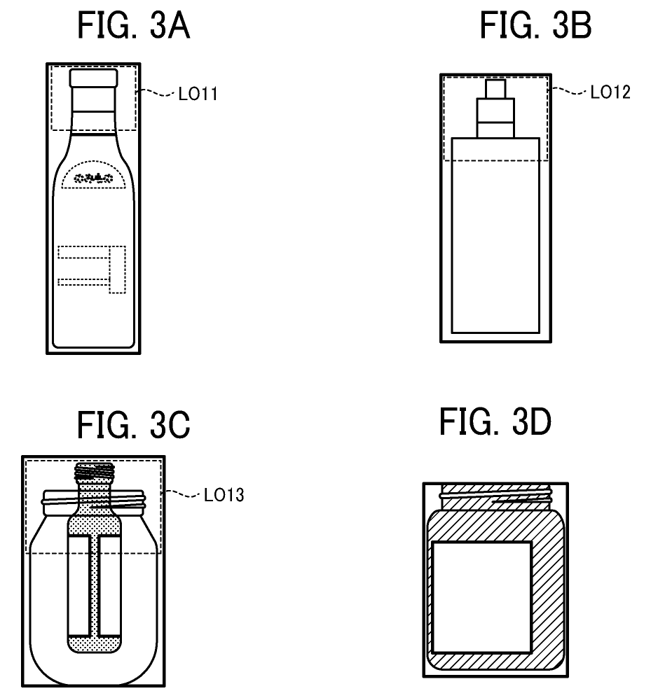

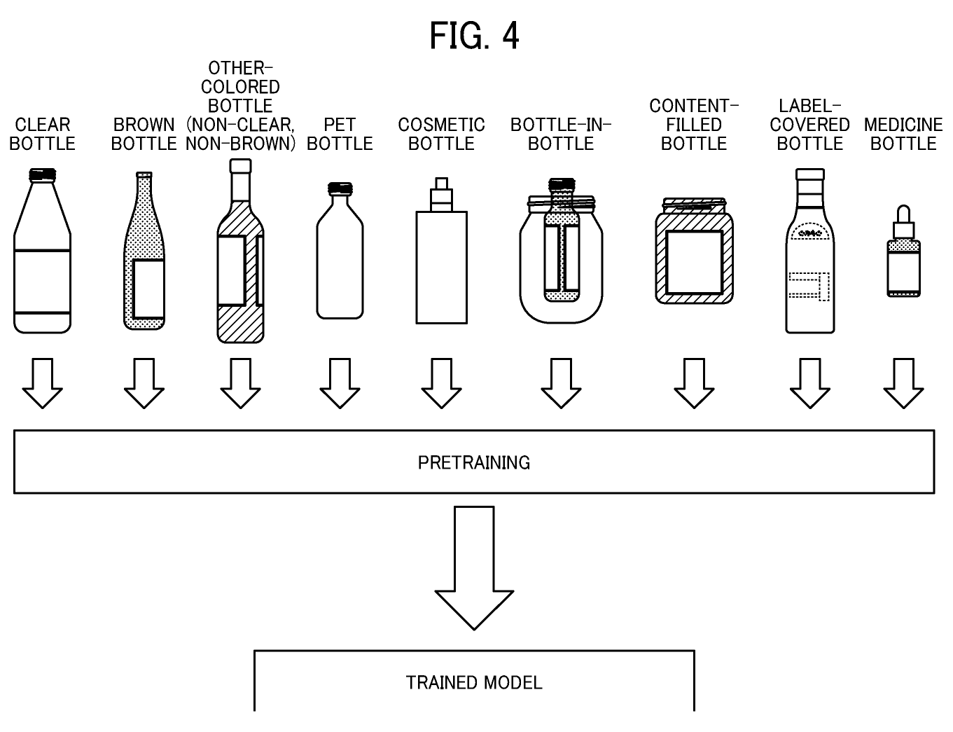

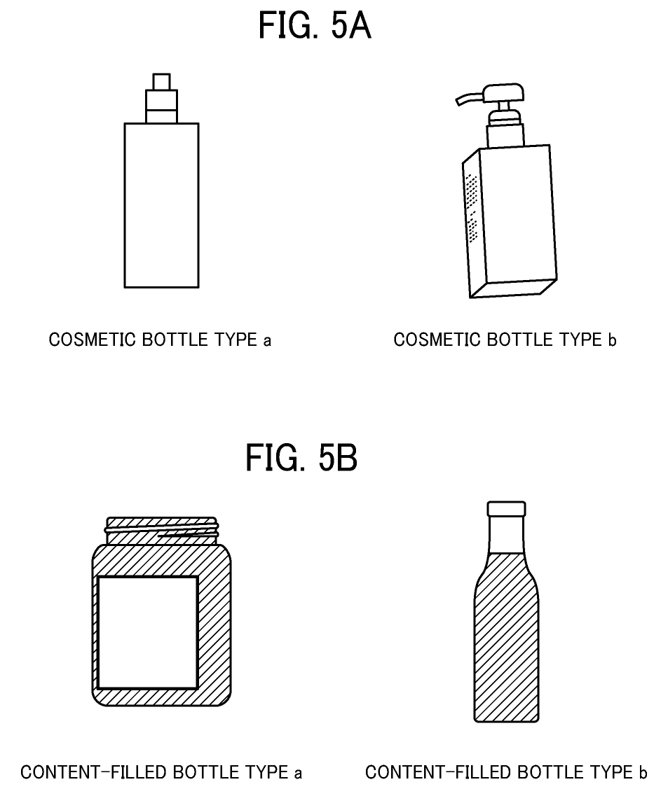

FIG. 1 is a diagram illustrating an example of a configuration of a sorting system 1 according to a first embodiment. FIGS. 2A to 2G are diagrams illustrating specific examples of selection targets and foreign objects excluded from selection in the sorting system 1 according to the first embodiment. FIGS. 3A to 3D are diagrams illustrating examples of images to be used to increase the accuracy of classifying bottles in the sorting system 1 according to the first embodiment. FIG. 4 is a diagram illustrating a training process for a trained model used by a classification device 10 according to the first embodiment. FIGS. 5A and 5B are diagrams each illustrating an example of finer classification of types to be output by a trained model used by the classification device 10 according to the first embodiment. The configuration and operation of the sorting system 1 according to the present embodiment is described below with reference to FIGS. 1 to 5B).

In practice, foreign objects other than the bottles to be selected such as clear bottles, brown bottles, and bottles of colors other than clear and brown may be mixed in the bottles conveyed on a belt conveyor. The bottle of a color other than clear and brown may be referred to as an other-colored bottle in the following description. The bottle to be selected may be referred to as a “selection target” in the following description. Examples of selection targets include empty bottles that previously contained beverages and empty bottles that previously contained food. An empty bottle that previously contained beverage and an empty bottle that previously contained food may be referred to as a beverage bottle and a food bottle, respectively, in the following description. Examples of foreign objects excluded from selection include empty bottles that previously contained substances other than food or beverages. Details of specific examples of foreign objects are described later. An empty bottle that previously contained a substance other than food or a beverage may be referred to as a non-food/beverage bottle or a non-food and beverage bottle in the following description. An example of a food bottle is an empty bottle that previously contained a jammed food. An example of a non-food/beverage bottle is an empty bottle that previously contained a cosmetic liquid or a cosmetic cream. An empty bottle that previously contained a cosmetic liquid or a cosmetic cream may be referred to as a cosmetic bottle in the following description. Beverage bottles and food bottles may be collectively referred to as “food/beverage bottles,” even when referring to only one type, such as a food bottle or a beverage bottle, in the following description.

Most beverage bottles and non-food/beverage bottles have shapes that include a mouth portion that is the narrowest part of the bottle’s width, a neck portion connected to the mouth portion, a body portion wider than the neck portion, and a shoulder portion connecting the neck portion and the body portion. Further, most beverage bottles and non-food/beverage bottles have cylindrical shapes in the body portions. Further, most beverage bottles and non-food/beverage bottles have characteristic shapes in the mouth, neck, and shoulder portions. On the other hand, most food bottles have a mouth portion that is wider than that of beverage bottles or non-food/beverage bottles. Further, most food bottles have body portions whose width is approximately equal to the mouth portion. Further, most food bottles have cylindrical shapes, without a neck portion or shoulder portion. An empty bottle having a cylindrical shape without a neck or shoulder portion may be referred to as a “cylindrical bottle” in the following description.

The sorting system 1 that can increase the accuracy of sorting objects into selection targets and foreign objects is described below in detail.

As illustrated in FIG. 1, the sorting system 1 includes a classification device 10, a camera 20, a sorting device 30, and a belt conveyor 40. The classification device 10, the camera 20, and the sorting device 30 can communicate with each other for data exchange.

In the following description of the present embodiment, the sorting system 1 illustrated in FIG. 1 is installed in a waste treatment facility where a group of bottles is conveyed on the belt conveyor 40. That is, in the following description, bottles are used as an example of objects to be sorted by the sorting system 1. In the present description, the term “bottle” is used as a broad concept that includes not only glass bottles but also plastic bottles, containers, polyethylene terephthalate (PET) bottles, and equivalents thereof. Further, for example, the selection targets to be recycled or processed from a group of bottles conveyed on the belt conveyor 40 are expected to be clear bottles (e.g., the one illustrated in FIG. 2A), brown bottles (e.g., the one illustrated in FIG. 2B), other-colored bottles, and PET bottles. Such beverage bottles as selection targets typically have shapes designed on the premise that a person will drink directly from the bottles or pour its contents into his or her mouth. The shape typically includes a circular opening of 2 to 3 cm in diameter with threads or a hook structure to allow sealing with a lid or a cap.

Examples of foreign objects excluded from selection include cosmetic bottles that previously contained liquids used for makeup, as illustrated in FIG. 2C, and bottles that contained liquids such as lotion, aroma oils, or medicinal solutions, as illustrated in FIG. 2C. The bottle that previously contained a liquid such as a lotion, an aroma oil, or a medicinal solution may be referred to as a medicine bottle in the following description. As illustrated in FIG. 2C, most cosmetic bottles and medicine bottles have various shapes, such as a spray type, a pump type, and a dripping type, designed for uses different from beverage bottles. Further, most cosmetic bottles and medicine bottles have non-cylindrical shapes as overall shapes in consideration of the design. In the case of a spray-type cosmetic bottle as illustrated in FIG. 3B, the body portion is similar to the clear bottle in color, pattern, and texture. Accordingly, it is difficult to distinguish such a spray-type cosmetic bottle from a clear bottle. The shape of the mouth portion of such a cosmetic bottle, namely, a spray-type cosmetic bottle, is designed to have a spray function, and this is a useful feature for type classification. To use the feature for type classification, a partial image of a bottle LO12 is extracted from a bottle image. The partial image of a bottle may be referred to as a partial-bottle image in the following description. The partial-bottle image LO12 includes the vicinity of the mouth portion of the bottle.

Further, examples of foreign objects excluded from selection include glass products such as cups, containers, and trays as illustrated in FIG. 2D. Such a glass product may be referred to as a glass container in the following description. Most such glass containers have non-cylindrical shapes, handles, and a variety of overall shapes.

The cosmetic bottles, the medicine bottles, and the glass containers described above are examples of non-food/beverage bottles.

Further, examples of foreign objects excluded from selection include bottles that have substantially the same shape as food bottles, but contain all or part of their contents as illustrated in FIG. 2E. Such a bottle may be referred to as a content-filled bottle in the following description. In the case of a content-filled bottle as illustrated in FIG. 3D, the entire surface except for the label area is coated with the contents, and the resulting pattern (texture) makes type classification easier. Accordingly, an image of a whole bottle is used for type classification. The image of a whole bottle image may be referred to as a whole-bottle image in the following description.

As illustrated in FIG. 2E, such a content-filled bottle is easily recognized when the texture (pattern or surface texture) of the portion other than the label is used as a factor for determination. Further, examples of foreign objects excluded from selection include bottles containing another bottle inside, as illustrated in FIG. 2F. Such a bottle may be referred to as bottle-in-bottle or a bottle-in-bottle object in the following description. When such a bottle-in-bottle object is grasped as a selection target by the sorting device 30 such as a robot, which is described later, multiple bottles of different types may be picked up together. To cope with this, the bottle-in-bottle objects are treated as foreign objects, but not as selection targets. Further, a bottle-in-bottle object is easily recognized when the texture other than the label, or the overall shape is used as a factor for determination. In the example of FIG. 2F, a colored bottle such as a brown bottle is visible inside a clear bottle, and this condition is used as a texture-based feature. Further in the example of FIG. 2F, the colored bottle protrudes from the clear bottle, and this condition is used as a shape-based feature. In the case of a bottle-in-bottle object as illustrated in FIG. 3C, the body portion is similar to the clear bottle in color, pattern, and texture. Accordingly, it is difficult to distinguish such a bottle-in-bottle object from a clear bottle. In such a bottle-in-bottle object, a mixture of the colors, patterns, and textures of both the brown bottle and the clear bottle is present near the mouth portion, and this is a useful feature for type classification. To use the feature for type classification, a partial-bottle image LO13 including the vicinity of the mouth portion of the bottle is extracted from a bottle image.

Further, examples of foreign objects excluded from selection include a bottle whose surface is largely covered by a label having a color different from the base color of the bottle, so that only a small area with the base color is visible, as illustrated in FIG. 2G. Such a bottle may be referred to as a label-covered bottle in the following description. As illustrated in FIG. 3A, such a label-covered bottle is covered with a label from the shoulder portion to the body portion and the base color is not visible. Due to this, type classification is affected by the color and pattern of the label. To cope with this, the vicinity of the mouth portion where the base color of the label-covered bottle can be checked is used as a useful feature for type classification. To use the feature for type classification, a partial-bottle image LO11 including the vicinity of the mouth portion of the bottle is extracted from a bottle image.

The selection targets and the foreign objects described above are examples. There may be another bottle structure of selection target and another structure of foreign object, in addition to the ones described above. The selection targets or the foreign objects may include a bottle other than the ones illustrated in FIGS. 2A to 2G.

The camera 20 is an imager that is located above the belt conveyor 40 on which a group of bottles is conveyed. The camera 20 has a predetermined angle of view, and images a predetermined area on the upper surface of the belt conveyor 40 from above the belt conveyor 40 at a constant frame rate. The predetermined angle of view may be specified by either a designer or a user. The predetermined area may be specified by either a designer or a user. Accordingly, the image captured by the camera 20 is an image of a group of bottles. The image of a group of bottles may be referred to as a bottle group image in the following description. The camera 20 transmits the bottle group image to the classification device 10. The camera 20 may be, for example, an imaging sensor or an area sensor.

The classification device 10 is a device that classifies or identifies the type of a bottle conveyed on the belt conveyor 40 based on a bottle group image captured by the camera 20. The bottle group image includes a group of bottles conveyed on the belt conveyor 40. The classification device 10 controls the operation of the sorting device 30 according to classification results indicating bottle types. Each classification result reflects a type-identification. In other words, classifying the type of a bottle includes or involves identifying the type of a bottle. Accordingly, in the description of embodiments, the terms “classify” and “classification” may be used interchangeably with “identify” and “identification”, respectively.

The classification device 10 uses a trained model to classify bottle types. As illustrated in FIG. 4, a trained model used by the classification device 10 is generated through pretraining using machine learning. During pretraining, bottle images of foreign objects such as a cosmetic bottle, a medicine bottle, a glass container, a content-filled bottle, a bottle-in-bottle object, and a label-covered bottle are used as training data, in addition to bottle images of selection targets such as a clear bottle, a brown bottle, a bottle of a color other than clear and brown, and a PET bottle. The trained model obtained by using such machine learning can classify bottle types by comprehensively evaluating various features such as shapes of mouth portions, overall shapes, colors, and textures of bottles without explicitly defining fixed criteria for determination or a fixed factor for determination. Further, actively training not only with bottle images of selection targets but also with bottle images of foreign objects excluded from selection can increase the recognition accuracy for bottle type classification. The classification device 10 uses a plurality of trained models (a trained model B and a trained model C described later) for the above-described trained models. The trained model B is a trained model that was trained using an image of a whole bottle (whole-bottle image) for each bottle type as described above. That is, the trained model B receives an image of a whole bottle (whole-bottle image) as an input and outputs at least a classification result indicating the type of the bottle present in the bottle image. The trained model C is a trained model that was trained using a partial image of a bottle (partial-bottle image) including the vicinity of the mouth portion of a bottle, which is useful for bottle type classification, among the various types of bottle images described above. That is, the trained model C receives a partial-bottle image as an input and outputs at least a classification result indicating the type of a bottle present in the partial-bottle image. By using the plurality of trained models for classifying the bottle types as described above, the recognition accuracy for bottle type classification can be further increased.

The classification results indicating bottle types that are output by the above-described trained models are not limited to the types as illustrated in FIGS. 2A to 2G, and types that are more finely classified may be output. For example, for cosmetic bottles, a type that is more finely classified, such as a spray-type cosmetic bottle (cosmetic bottle type a) or a pump-type cosmetic bottle (cosmetic bottle type b), may be output based on the shape of a mouth portion, as illustrated in FIG. 5A. Further, for content-filled bottles, a type that is more finely classified, such as a content-filled bottle filled with jam-like contents (content-filled bottle type a) or a content-filled bottle filled with non-jam-like contents (content-filled bottle type b), may be output, as illustrated in FIG. 5B. The types that are more finely classified may be output in addition to the types illustrated in FIGS. 2A to 2G (so-called types in a broad category).

Further, the trained models are not limited to the separate trained models such as the trained model B and the trained model C. A single trained model that can receive both whole-bottle images and partial-bottle images and classify bottle types may be used.

The trained model B corresponds to a “first trained model” in the present disclosure, and the trained model C corresponds to a “second trained model” in the present disclosure.

The sorting device 30 is a device that sorts out a selection target by picking up the selection target from a group of bottles conveyed in a conveying direction CD by the belt conveyor 40 under the control of the classification device 10, and transports the picked-up selection target to a predetermined space on the side of the belt conveyor 40. The predetermined space may be specified by either a designer or a user.

The belt conveyor 40 is a conveyor device that conveys a group of bottles placed on the belt conveyor 40 in the conveying direction CD. That is, the belt conveyor 40 forms a conveying path along which the group of bottles is conveyed in the conveying direction CD.

### Hardware Configuration of Classification Device

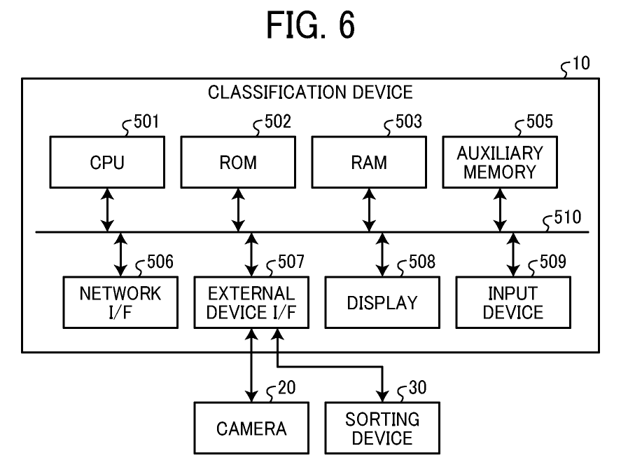

FIG. 6 is a block diagram illustrating a hardware configuration of the classification device 10 according to the first embodiment. The hardware configuration of the classification device 10 according to the present embodiment is described below with reference to FIG. 6.

As illustrated in FIG. 6, the classification device 10 includes a central processing unit (CPU) 501, a read-only memory (ROM) 502, a random-access memory (RAM) 503, an auxiliary memory 505, a network interface (I/F) 506, an external device I/F 507, a display 508, and an input device 509.

The CPU 501 is a processing device that controls the entire operation of the classification device 10. The ROM 502 is a nonvolatile memory that stores programs such as the initial program loader (IPL) that is the first program executed by the CPU 501. The RAM 503 is a volatile memory used as a working area for the CPU 501.

The auxiliary memory 505 is a nonvolatile memory that stores various types of data such as configuration information and programs. Examples of the auxiliary memory 505 include a hard disk drive (HDD) and a solid-state drive (SSD).

The network I/F 506 is an interface circuit for data communication through a network. The network I/F 506 is, for example, a network interface card (NIC) that enables communication by a protocol of transmission control protocol (TCP)/internet protocol (IP). The network I/F 506 may be a communication interface having wireless communication functionality based on standards such as WI-FI (registered trademark).

The external device I/F 507 is an interface circuit for communicating with external devices such as the camera 20 and the sorting device 30. The external device I/F 507 is an interface circuit that conforms to a serial communication standard such as a universal serial bus (USB) communication, BLUETOOTH (registered trademark), or a fieldbus. In the example illustrated in FIG. 6, the camera 20 and the sorting device 30 are connected to the external device I/F 507. However, the present disclosure is not limited this, and the camera 20 and the sorting device 30 may be connected to different interface circuits. Further, at least one of the camera 20 and the sorting device 30 may perform data communication via the network I/F 506.

The display 508 is a display device such as a liquid crystal display or an organic light-emitting diode (OLED) display that displays various screens.

The input device 509 is a device such as a mouse, a keyboard, or a touch panel that allows a user to perform an input operation.

The CPU 501, the ROM 502, the RAM 503, the auxiliary memory 505, the network I/F 506, the external device I/F 507, the display 508, and the input device 509 are connected to each other via a bus 510 such as an address bus and a data bus for communication.

The hardware configuration of the classification device 10 illustrated in FIG. 6 is one example. One or more of the components illustrated in FIG. 6 may be omitted, or one or more different components may be included in the hardware configuration illustrated in FIG. 6.

### Functional Configuration and Operation of Sorting System

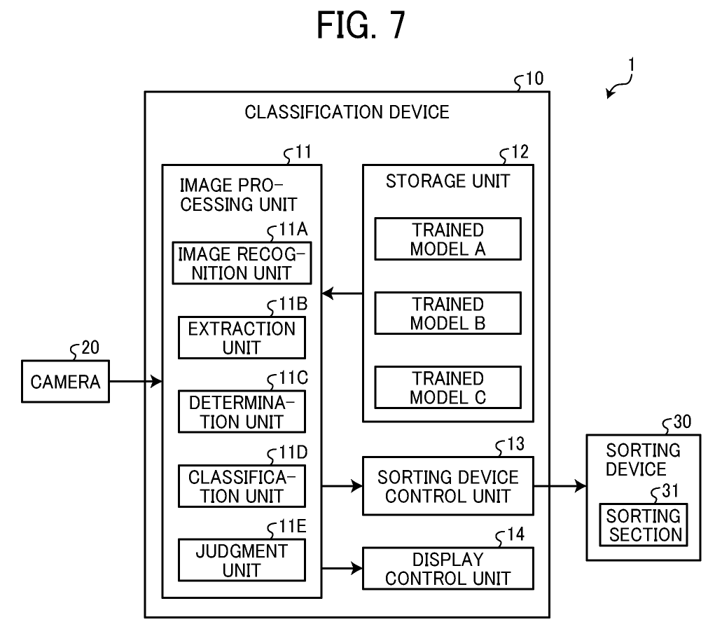

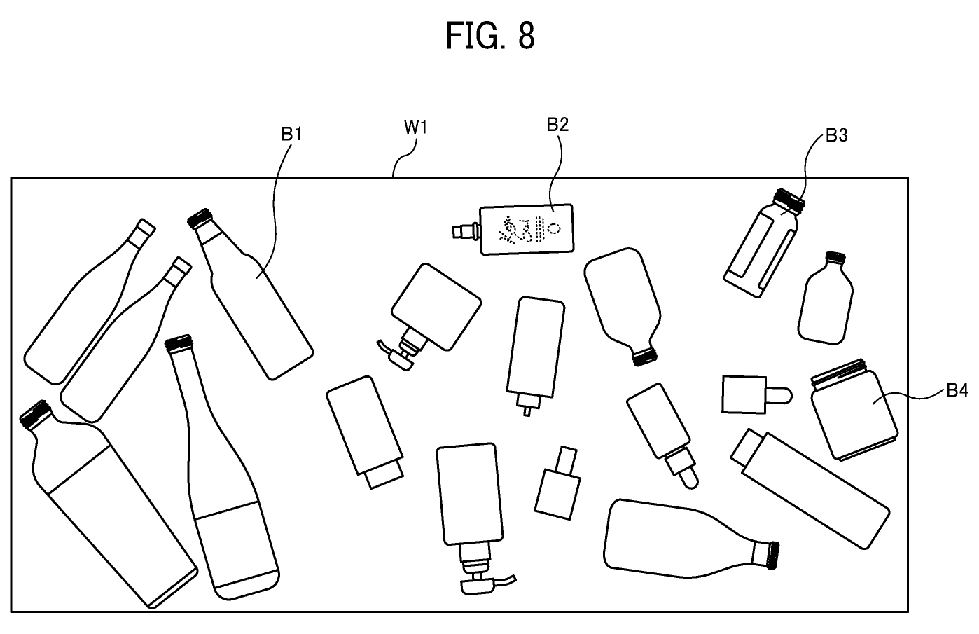

FIG. 7 is a block diagram illustrating an example of a functional configuration of the sorting system 1 according to the first embodiment. FIGS. 8 to 15 are diagrams each illustrating a bottle image used in an example of operation of the image processing unit 11 of the classification device 10 according to the first embodiment. The functional configuration and operation of the sorting system 1 according to the present embodiment is described below with reference to FIGS. 7 to 15.

As illustrated in FIG. 7, the classification device 10 includes an image processing unit 11, a storage unit 12, a sorting device control unit 13, and a display control unit 14.

The image processing unit 11 is a functional unit that receives a bottle group image of a group of bottles conveyed on the belt conveyor 40 via the external device I/F 507. The bottle group image is captured by the camera 20. The image processing unit 11 executes various processing on the received bottle group image to classify the type of each bottle present in the bottle group image. As illustrated in FIG. 7, the image processing unit 11 includes an image recognition unit 11A, an extraction unit 11B, a determination unit 11C, a classification unit 11D, and a judgment unit 11E. The image processing unit 11 is implemented by, for example, the CPU 501 illustrated in FIG. 6 executing a program.

The image recognition unit 11A is a functional unit that recognizes the bottle image of a bottle from a bottle group image captured by the camera 20. Subsequently, the image recognition unit 11A recognizes the contour of the bottle from the bottle image using a trained model A for detecting contours of bottles based on instance segmentation. The contour of a bottle may be referred to as a bottle contour in the following description. Instance segmentation is a method for identifying object regions in an image and recognizing each object by segmenting its region. Then, the image recognition unit 11A recognizes a rectangle that has the minimum area and encloses the recognized bottle contour. A rectangle that has the minimum area and encloses a bottle contour may be referred to as a bottle bounding rectangle in the following description.

The trained model A may be a trained model that detects a bounding box for each bottle by object detection instead of instance segmentation. The bounding box is a rectangle that encloses an object included in an image and has sides parallel to the X direction of the image (horizontal direction of the image) and the Y direction of the image (vertical direction of the image). In this case, the image recognition unit 11A recognizes a bounding box for each bottle in the bottle group image using the trained model A based on object detection, and recognizes a bottle contour included in each bounding box. Then, the image recognition unit 11A recognizes a bottle bounding rectangle that has the minimum area and encloses the recognized bottle contour.

The extraction unit 11B is a functional unit that extracts a bottle image (whole-bottle image) from a bottle group image based on the bottle contour recognized by the image recognition unit 11A, and extracts a partial-bottle image including the vicinity of the mouth portion of the bottle from the whole-bottle image. The whole-bottle image and the partial-bottle image extracted by the extraction unit 11B correspond to a “first image” and a “second image,” respectively, in the present disclosure.

Specifically, the extraction unit 11B performs upright correction on the bottle image extracted from the bottle group image. For example, the upright correction is performed with reference to the direction from the contour center coordinates to the rectangle center coordinates, as described later. Then, the extraction unit 11B extracts an image other than the cylindrical portion of the bottle as a partial-bottle image from the upright-corrected bottle image.

The extraction unit 11B may use a trained model to extract the partial-bottle image from the upright-corrected bottle image. The extraction unit 11B may extract, as a partial-bottle image, an image of a predetermined region in an upper part of the upright-corrected bottle image. In this case, the extraction unit 11B may extract, as a partial-bottle image, a region (range) extending from the top downward to cover a predetermined percentage, for example, several tens of percent, of the upright-corrected bottle image. The predetermined percentage may be specified by either a designer or a user.

The determination unit 11C is a functional unit that determines whether to use an image of a whole bottle (whole-bottle image) or a partial bottle image as an image for type classification for a bottle to be classified. The bottle to be classified may be referred to as a target bottle in the following description. The whole-bottle image is an image of the whole target bottle.

Specifically, the determination unit 11C calculates the coordinates of the area centroid of the region enclosed by the bottle contour of the target bottle recognized by the image recognition unit 11A. The coordinates of the area centroid may be referred to as contour centroid coordinates in the following description. After calculating the contour centroid coordinates, the determination unit 11C outputs the calculated contour centroid coordinates to the sorting device control unit 13. Subsequently, the determination unit 11C calculates the center coordinates of the bottle bounding rectangle of the target bottle recognized by the image recognition unit 11A. The center coordinates of the bottle bounding rectangle may be referred to as rectangle center coordinates in the following description. Subsequently, the determination unit 11C calculates the value of the aspect ratio of the bottle bounding rectangle of the target bottle recognized by the image recognition unit 11A based on the width and height of the bottle bounding rectangle. The value of an aspect ratio may be referred to as an aspect ratio value in the following description. Then, the determination unit 11C determines whether the distance between the contour centroid coordinates and the rectangle center coordinates is less than a threshold TH1. The distance between the contour centroid coordinates and the rectangle center coordinates may be referred to as an inter-coordinate distance in the following description. When the inter-coordinate distance is less than the threshold TH1, the determination unit 11C further determines whether the calculated aspect ratio value is less than a threshold TH2. When the inter-coordinate distance is equal to or greater than the threshold TH1 or when the aspect ratio value is equal to or greater than the threshold TH2, it is determined that the target bottle has a feature from the neck portion to the mouth portion. Accordingly, the determination unit 11C determines to use a partial-bottle image of the target bottle as an image for type classification for the target bottle. On the other hand, when the inter-coordinate distance is less than the threshold TH1 and the aspect ratio value is less than the threshold TH2, it is determined that the target bottle is likely to have a cylindrical shape without a neck portion and a shoulder portion. Accordingly, it is determined that classification using the whole bottle is more accurate than using a partial bottle. As a result, the determination unit 11C determines to use the whole-bottle image of the target bottle as an image for type classification for the target bottle.

The classification unit 11D is a functional unit that classifies the type of a target bottle. Specifically, when the determination unit 11C determines to use the whole-bottle image of the target bottle as an image for type classification, the classification unit 11D inputs the whole-bottle image of the target bottle to the trained model B. Then, the type of the target bottle present in the whole-bottle image is classified using the trained model B, and the classification unit 11D obtains the type of the target bottle. On the other hand, when the determination unit 11C determines to use a partial-bottle image of the target bottle as an image for type classification, the classification unit 11D inputs the partial-bottle image of the target bottle to the trained model C. Then, the type of the target bottle present in the partial-bottle image is classified using the trained model C, and the classification unit 11D obtains the type of the target bottle. That is, the classification unit 11D classifies the type of the target bottle using the trained model B and the trained model C. The classification unit 11D outputs the classification result to the display control unit 14.

The trained model B may be a single trained model including the functionality of the trained model A described above. In this case, the trained model is a model having both the detection and type classification functions with respect to bottle contours.

The judgment unit 11E is a functional unit that determines whether a target bottle is either a selection target or a foreign object based on the type of the target bottle classified by the classification unit 11D. For example, when the type of the target bottle classified by the classification unit 11D is a clear bottle, a brown bottle, a bottle of a color other than clear and brown, or a PET bottle, the judgment unit 11E determines that the target bottle is a selection target. Further, when the type of the target bottle classified by the classification unit 11D is a cosmetic bottle, a medicine bottle, a glass container, a content-filled bottle, a bottle-in-bottle object, or a label-covered bottle, the judgment unit 11E determines that the target bottle is a foreign object excluded from selection. The judgment unit 11E outputs the determination result to the sorting device control unit 13 and the display control unit 14.

The storage unit 12 is a functional unit that stores the trained models A to C. The storage unit 12 is implemented by the auxiliary memory 505 illustrated in FIG. 6. That is, the image processing unit 11 refers to the storage unit 12 and uses the trained models A to C stored in the storage unit 12.

The trained models A to C are not limited to being stored in the storage unit 12. For example, at least one of the trained models A, B, and C may be stored in an external server, and the image processing unit 11 may access the server to use the trained models A, B, or C.

The sorting device control unit 13 is a functional unit that communicates with the sorting device 30 via the external device I/F 507 and controls the operation of the sorting device 30. Specifically, when the determination result received from the judgment unit 11E indicates that a target bottle is a selection target, the sorting device control unit 13 sets the contour centroid coordinates of the target bottle received from the determination unit 11C to coordinates indicating a pickup point. The pickup point is a point at which a sorting section 31 picks up the selection target. The coordinates indicating a pickup point may be referred to as pickup point coordinates in the following description. The pickup point coordinates set by the sorting device control unit 13 are coordinates in the coordinate system of the bottle group image, that is, the coordinate system of the camera 20. In view of this, the sorting device control unit 13 converts the set pickup point coordinates of the coordinate system of the camera 20 into pickup point coordinates of the coordinate system of the sorting device 30. The sorting device control unit 13 notifies the sorting device 30 of information including the converted pickup point coordinates. The information notified to the sorting device 30 in this case can be regarded as a determination result obtained by the image processing unit 11 (e.g., the judgment unit 11E) and indicating that the target bottle included in the bottle group image is a selection target. The sorting device control unit 13 is implemented by, for example, the CPU 501 illustrated in FIG. 6 executing a program.

The display control unit 14 is a functional unit that controls the display operation of the display 508. The display control unit 14 displays the classification result received from the classification unit 11D on the display 508, as described later. Further, the display control unit 14 may display the determination result received from the judgment unit 11E on the display 508 in addition to the above-described classification result, as described later. The display control unit 14 is implemented by, for example, the CPU 501 illustrated in FIG. 6 executing a program.

As illustrated in FIG. 7, the sorting device 30 includes the sorting section 31. The sorting device 30 sequentially moves the sorting section 31 to a position directly above the pickup point coordinates of a target bottle that is a selection target indicated in the information notified from the sorting device control unit 13. The sorting section 31 picks up the target bottle from a group of bottles conveyed on the belt conveyor 40 using the pickup point coordinates as a pickup point, thereby sorting out the target bottle from the group of bottles. The sorting section 31 is implemented by, for example, a robot hand or a suction pad.

When the sorting section 31 is implemented by a robot hand, a grasping position of the robot hand is set such that the grasping position aligns with the pickup point on a target bottle that is a selection target. Accordingly, the sorting section 31 grasps the target bottle with the robot hand to pick up the target bottle. When the sorting section 31 is implemented by a suction pad, a suction position of the suction pad is set such that the suction position aligns with the pickup point on a target bottle that is a selection target. Accordingly, the sorting section 31 performs suction with the suction pad to pick up the target bottle. The sorting section 31 is movable in the horizontal direction and the vertical direction. The sorting section 31 lifts the selection target picked up from the group of bottles in the vertical direction and moves the selection target in the horizontal direction. Accordingly, the sorting section 31 transports the selection target into a first box located outside the belt conveyor 40 along the side surface of the belt conveyor 40. On the other hand, the foreign objects excluded from selection are not picked up by the sorting section 31. The foreign objects are conveyed to the terminal end of the belt conveyor 40 in the conveying direction CD while remaining on the belt conveyor 40. Then, the foreign objects fall into a second box located at the terminal end of the belt conveyor 40.

At least a part of the functional units of the image processing unit 11, the sorting device control unit 13, and the display control unit 14 illustrated in FIG. 7 may be implemented by hardware such as an integrated circuit or a combination of software and hardware. Examples of the integrated circuit include a field-programmable gate array (FPGA) and an application-specific integrated circuit (ASIC).

The image recognition unit 11A, the extraction unit 11B, the determination unit 11C, the classification unit 11D, the judgment unit 11E, the sorting device control unit 13, and the display control unit 14 illustrated in FIG. 7 are the conceptual representations of the functions, and the functional configuration thereof is not limited thereto. For example, multiple functional units of the classification device 10 illustrated as independent units in FIG. 7 may be configured as a single functional unit. Further, functions provided by a single functional unit of the classification device 10 illustrated in FIG. 7 may be divided and allocated to multiple functional units. Further, the functional units of the classification device 10 are not necessarily software modules clearly configured as individual blocks as illustrated in FIG. 7. The functions of the functional units may be implemented as a whole by the execution of a program on the classification device 10.

Examples of operation of the image processing unit 11 of the classification device 10 are described below with reference to FIGS. 8 to 15.

For example, when a bottle group image W1 as illustrated in FIG. 8 is captured by the camera 20, the bottle group image W1 includes a first bottle image B1, a second bottle image B2, a third bottle image B3, and a fourth bottle image B4. The first bottle image B1 and the third bottle image B3 are images of beverage bottles, the second bottle image B2 is an image of a cosmetic bottle, and the fourth bottle image B4 is an image of a food bottle. An example of operation of the image processing unit 11 for each of the first bottle image B1, the second bottle image B2, the third bottle image B3, and the fourth bottle image B4 is described below.

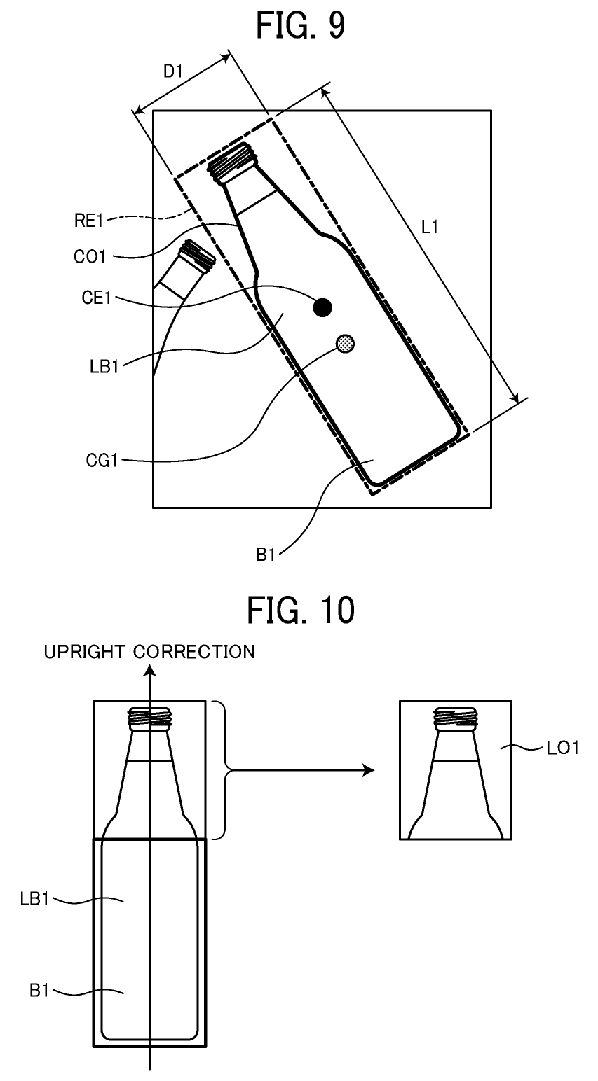

### Operation Example 1 (FIGS. 9 and 10): First Bottle Image B1

As illustrated in FIG. 9, the first bottle image B1 is an image of a label-covered bottle, and includes a label image LB1 that covers the entire body of the bottle, but not the mouth portion.

In FIG. 9, the image recognition unit 11A recognizes a bottle contour CO1 in the first bottle image B1. Subsequently, the image recognition unit 11A recognizes a bottle bounding rectangle RE1 with respect to the bottle contour CO1.

Subsequently, the determination unit 11C calculates contour centroid coordinates CG1 in the bottle contour CO1. Subsequently, the determination unit 11C calculates rectangle center coordinates CE1 in the bottle bounding rectangle RE1. Subsequently, the determination unit 11C calculates an aspect ratio value L1/D1 corresponding to the aspect ratio (L1:D1) of the bottle bounding rectangle RE1 from the width and height of the bottle bounding rectangle RE1.

Subsequently, the determination unit 11C determines whether the inter-coordinate distance between the contour centroid coordinates CG1 and the rectangle center coordinates CE1 is less than the threshold TH1. In FIG. 9, the determination unit 11C determines that the inter-coordinate distance is equal to or greater than the threshold TH1. Since the inter-coordinate distance is equal to or greater than the threshold TH1, the determination unit 11C determines to use a partial-bottle image as an image for type classification.

Subsequently, the extraction unit 11B extracts the first bottle image W1 from the bottle group image B1. Since a partial-bottle image is determined to be used as an image for type classification with respect to the first bottle image B1, the extraction unit 11B performs upright correction on the first bottle image B1 extracted from the bottle group image W1 as illustrated in FIG. 10. Subsequently, the extraction unit 11B extracts a partial-bottle image LO1 from the first bottle image B1 after upright correction.

Subsequently, the classification unit 11D inputs the partial-bottle image LO1 to the trained model C and classifies the type of the bottle present in the first bottle image B1. The type of the bottle present in the first bottle image B1 is determined to be a label-covered bottle.

Subsequently, the judgment unit 11E determines whether the bottle present in the first bottle image B1 is a selection target or a foreign object based on the type classified by the classification unit 11D. Since the bottle present in the first bottle image B1 is a label-covered bottle, the bottle is determined to be a foreign object.

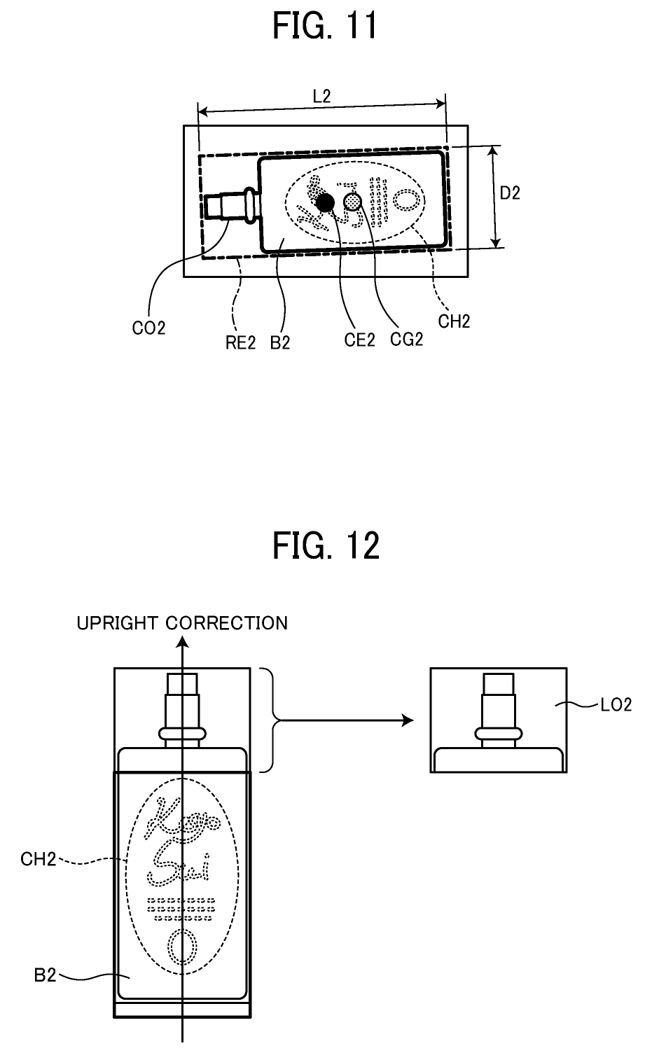

### Operation Example 2 (FIGS. 11 and 12): Second Bottle Image B2

As illustrated in FIG. 11, the second bottle image B2 is an image of a cosmetic bottle with printing, and includes a character image CH2 over most of the body of the bottle.

In FIG. 11, the image recognition unit 11A recognizes a bottle contour CO2 in the second bottle image B2. Subsequently, the image recognition unit 11A recognizes a bottle bounding rectangle RE2 with respect to the bottle contour CO2.

Subsequently, the determination unit 11C calculates contour centroid coordinates CG2 in the bottle contour CO2. Subsequently, the determination unit 11C calculates rectangle center coordinates CE2 in the bottle bounding rectangle RE2. Subsequently, the determination unit 11C calculates an aspect ratio value L2/D2 corresponding to the aspect ratio (L2:D2) of the bottle bounding rectangle RE2 from the width and height of the bottle bounding rectangle RE2.

Subsequently, the determination unit 11C determines whether the inter-coordinate distance between the contour centroid coordinates CG2 and the rectangle center coordinates CE2 is less than the threshold TH1. In FIG. 7, the determination unit 11C determines that the inter-coordinate distance is equal to or greater than the threshold TH1. Since the inter-coordinate distance is equal to or greater than the threshold TH1, the determination unit 11C determines to use a partial-bottle image as an image for type classification.

Subsequently, the extraction unit 11B extracts the second bottle image B2 from the bottle group image W1. Since a partial-bottle image is determined to be used as an image for type classification with respect to the second bottle image B2, the extraction unit 11B performs upright correction on the second bottle image B2 extracted from the bottle group image W1 as illustrated in FIG. 12. Subsequently, the extraction unit 11B extracts a partial-bottle image LO2 from the second bottle image B2 after upright correction.

Subsequently, the classification unit 11D inputs the partial-bottle image LO2 to the trained model C and classifies the type of the bottle present in the second bottle image B2. The type of the bottle present in the second bottle image B2 is determined to be a cosmetic bottle.

Subsequently, the judgment unit 11E determines whether the bottle present in the second bottle image B2 is a selection target or a foreign object based on the type classified by the classification unit 11D. Since the bottle present in the second bottle image B2 is a cosmetic bottle, the bottle is determined to be a foreign object.

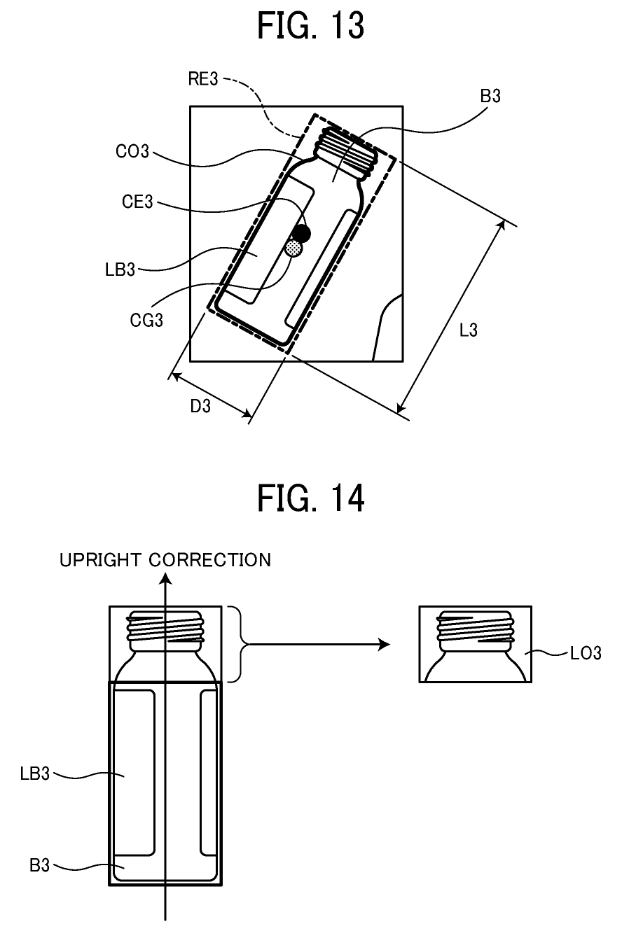

### Operation Example 3 (FIGS. 13 and 14): Third Bottle Image B3

As illustrated in FIG. 13, the third bottle image B3 is an image of a brown bottle that is a beverage bottle with a label, and includes a label image LB3 that covers most of the body of the bottle.

In FIG. 13, the image recognition unit 11A recognizes a bottle contour CO3 in the third bottle image B3. Subsequently, the image recognition unit 11A recognizes a bottle bounding rectangle RE3 with respect to the bottle contour CO3.

Subsequently, the determination unit 11C calculates contour centroid coordinates CG3 in the bottle contour CO3. Subsequently, the determination unit 11C calculates rectangle center coordinates CE3 in the bottle bounding rectangle RE3. Subsequently, the determination unit 11C calculates an aspect ratio value L3/D3 corresponding to the aspect ratio (L3:D3) of the bottle bounding rectangle RE3 from the width and height of the bottle bounding rectangle RE3.

Subsequently, the determination unit 11C determines whether the inter-coordinate distance between the contour centroid coordinates CG3 and the rectangle center coordinates CE3 is less than the threshold TH1. In FIG. 13, the determination unit 11C determines that the inter-coordinate distance is less than the threshold TH1. Further, the determination unit 11C determines whether the calculated aspect ratio value is less than the threshold TH2. In FIG. 13, the determination unit 11C determines that the aspect ratio value is equal to or greater than the threshold TH2. Since the inter-coordinate distance is less than the threshold TH1 and the aspect ratio value is equal to or greater than the threshold TH2, the determination unit 11C determines to use a partial-bottle image as an image for type classification.

Subsequently, the extraction unit 11B extracts the third bottle image B3 from the bottle group image W1. Since a partial-bottle image is determined to be used as an image for type classification with respect to the third bottle image B3, the extraction unit 11B performs upright correction on the third bottle image B3 extracted from the bottle group image W1, as illustrated in FIG. 14. Subsequently, the extraction unit 11B extracts a partial-bottle image LO3 from the third bottle image B3 after upright correction.

Subsequently, the classification unit 11D inputs the partial-bottle image LO3 to the trained model C and classifies the type of the bottle present in the third bottle image B3. The type of the bottle present in the third bottle image B3 is determined to be a brown bottle.

Subsequently, the judgment unit 11E determines whether the bottle present in the third bottle image B3 is a selection target or a foreign object based on the type classified by the classification unit 11D. Since the bottle present in the third bottle image B3 is a brown bottle, the bottle is determined to be a selection target.

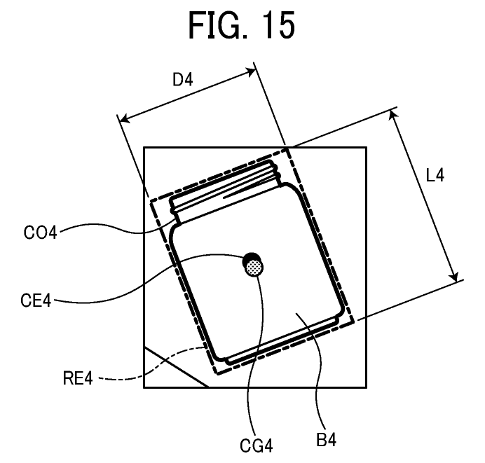

### Operation Example 4 (FIG. 15): Fourth Bottle Image B4

As illustrated in FIG. 15, the fourth bottle image B4 is an image of a content-filled bottle.

In FIG. 15, the image recognition unit 11A recognizes a bottle contour CO4 in the fourth bottle image B4. Subsequently, the image recognition unit 11A recognizes a bottle bounding rectangle RE4 with respect to the bottle contour CO4.

Subsequently, the determination unit 11C calculates contour centroid coordinates CG4 in the bottle contour CO4. Subsequently, the determination unit 11C calculates rectangle center coordinates CE4 in the bottle bounding rectangle RE4. Subsequently, the determination unit 11C calculates an aspect ratio value L4/D4 corresponding to the aspect ratio (L4:D4) of the bottle bounding rectangle RE4 from the width and height of the bottle bounding rectangle RE4.

Subsequently, the determination unit 11C determines whether the inter-coordinate distance between the contour centroid coordinates CG4 and the rectangle center coordinates CE4 is less than the threshold TH1. In FIG. 15, the determination unit 11C determines that the inter-coordinate distance is less than the threshold TH1. Further, the determination unit 11C determines whether the calculated aspect ratio value is less than the threshold TH2. In FIG. 15, the determination unit 11C determines that the aspect ratio value is less than the threshold TH2. Since the inter-coordinate distance is less than the threshold TH1 and the aspect ratio value is less than the threshold TH2, the determination unit 11C determines to use a whole-bottle image as an image for type classification.

Subsequently, the extraction unit 11B extracts the fourth bottle image B4 from the bottle group image W1. Since a whole-bottle image is determined to be used as an image for type classification with respect to the fourth bottle image B4, the determination unit 11C inputs the fourth bottle image B4 that is a whole-bottle image to the trained model B to classify the type of the bottle present in the fourth bottle image B4. The type of the bottle present in the fourth bottle image B4 is determined to be a content-filled bottle.

Subsequently, the judgment unit 11E determines whether the bottle present in the fourth bottle image B4 is a selection target or a foreign object based on the type classified by the classification unit 11D. Since the bottle present in the fourth bottle image B4 is a content-filled bottle, the bottle is determined to be a foreign object.

### Operational Flow of Classification Device

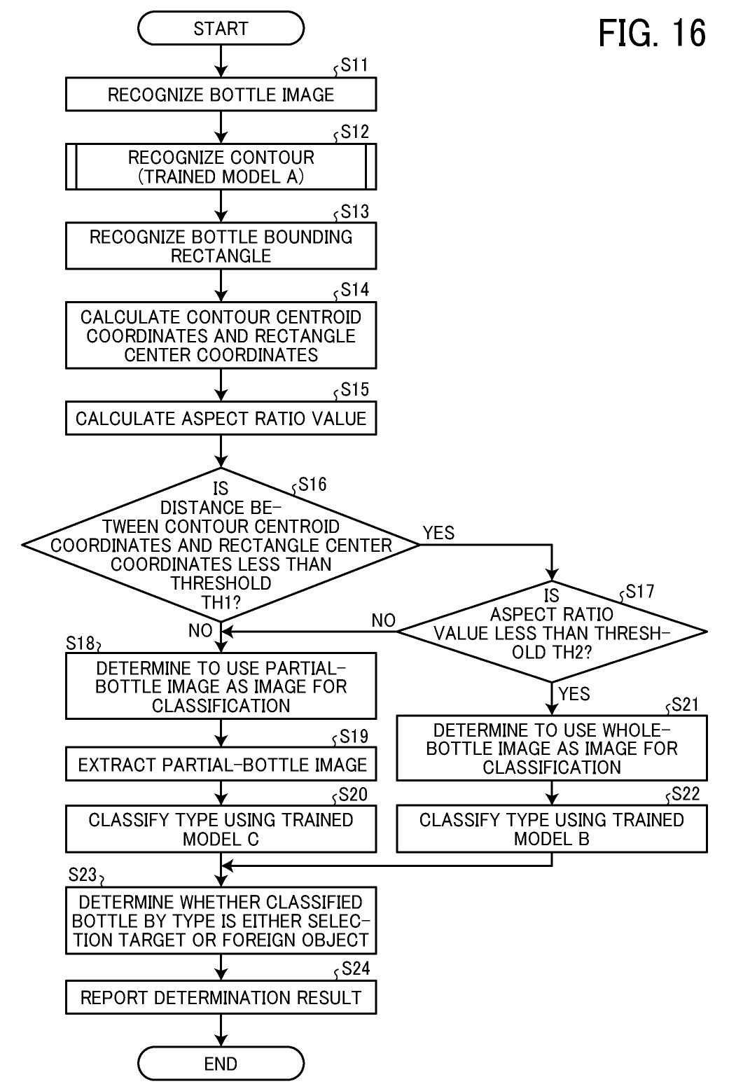

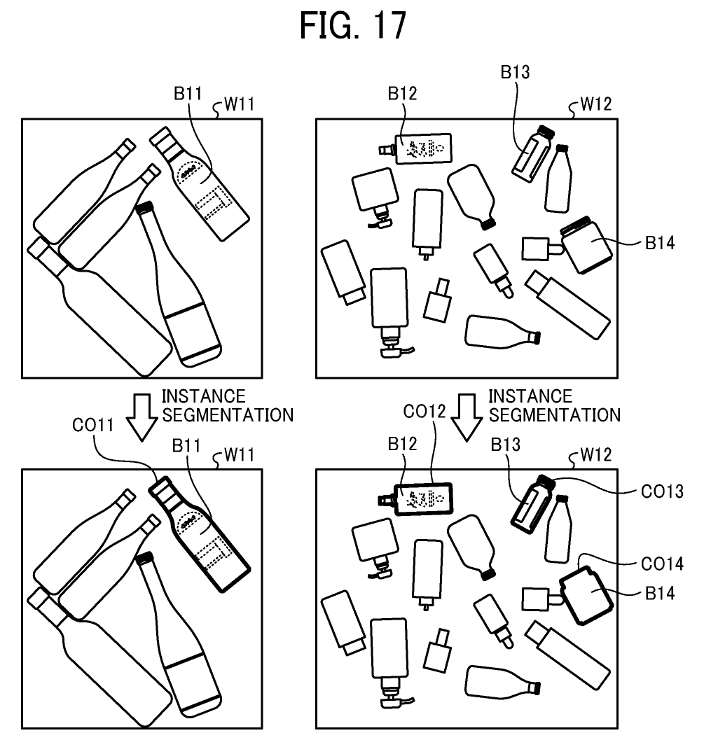

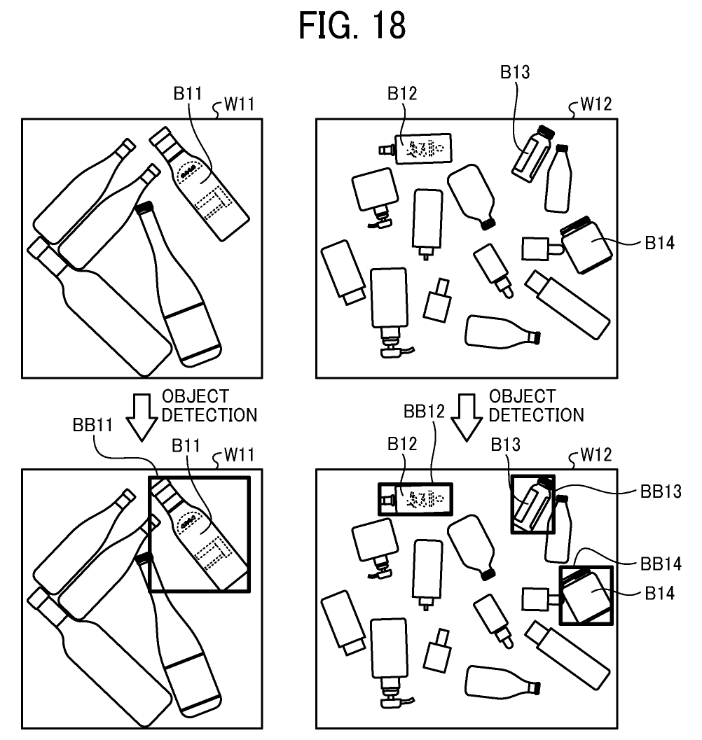

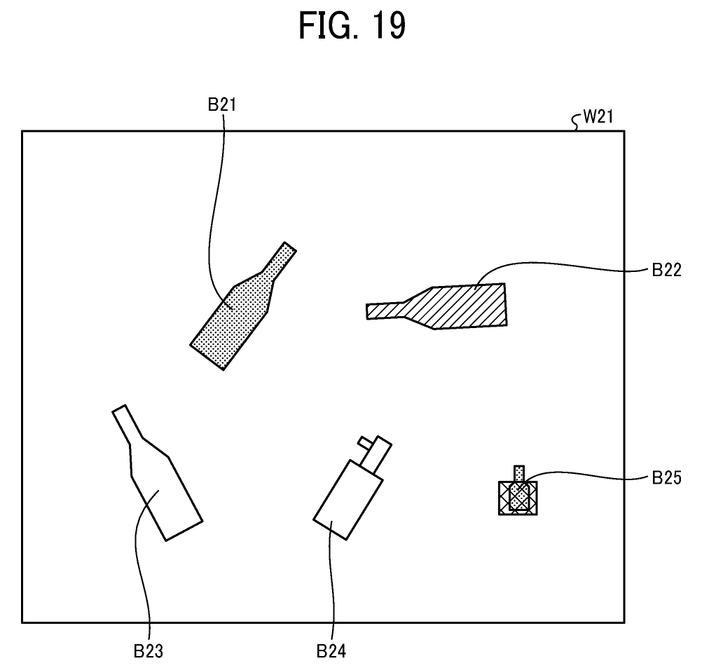

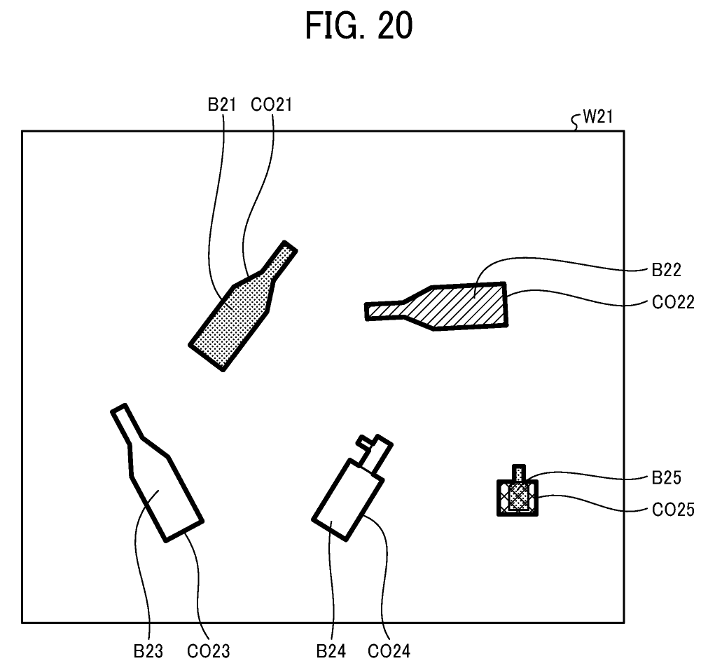

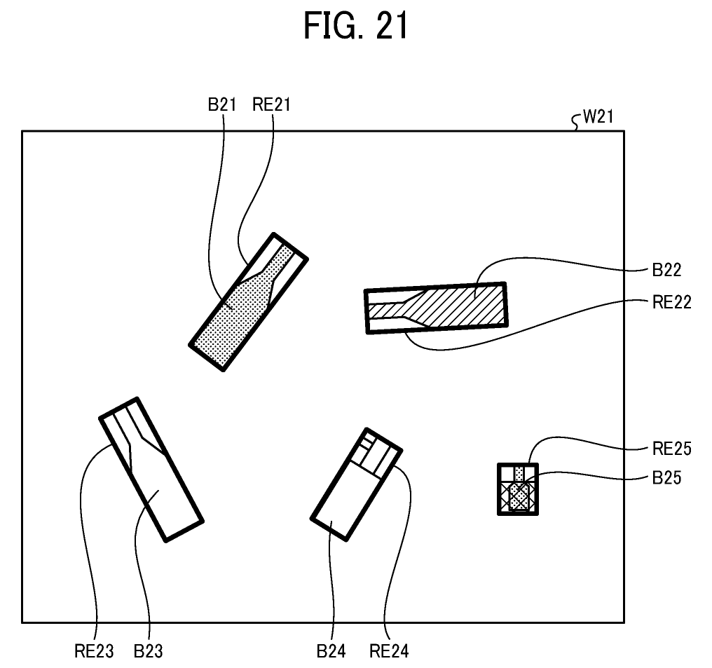

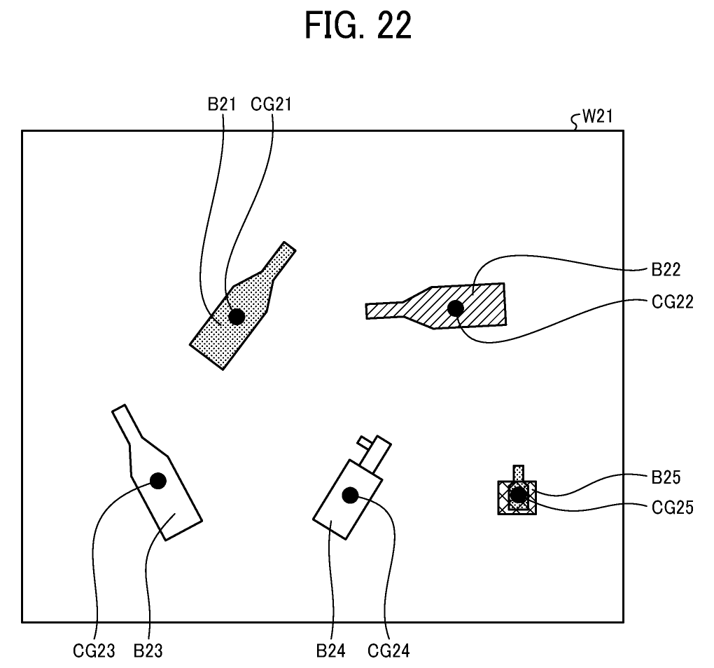

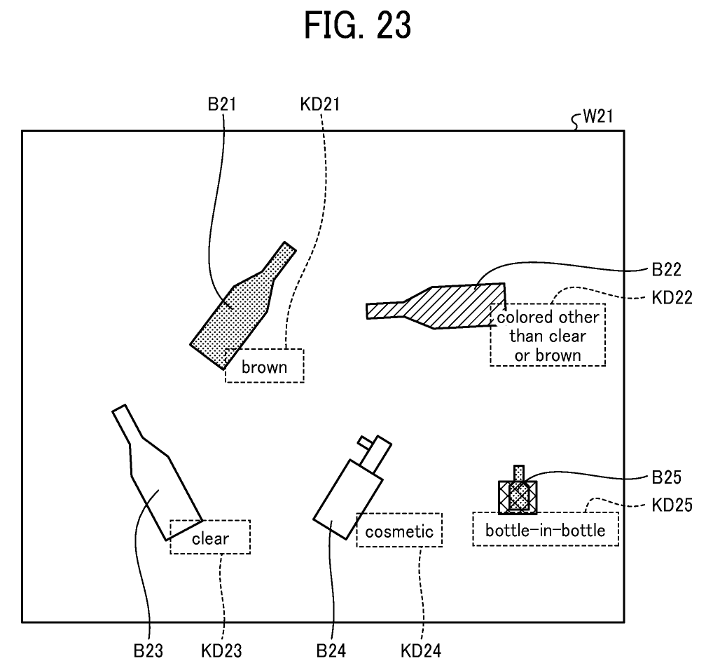

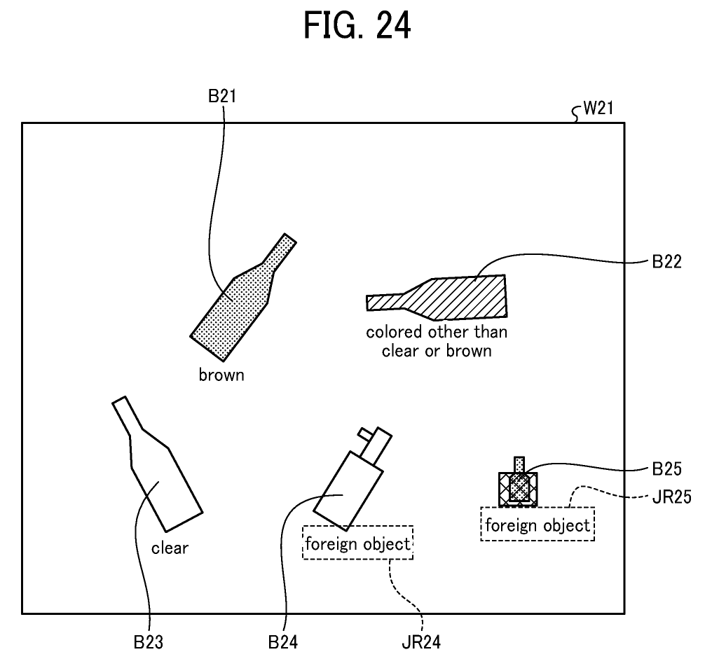

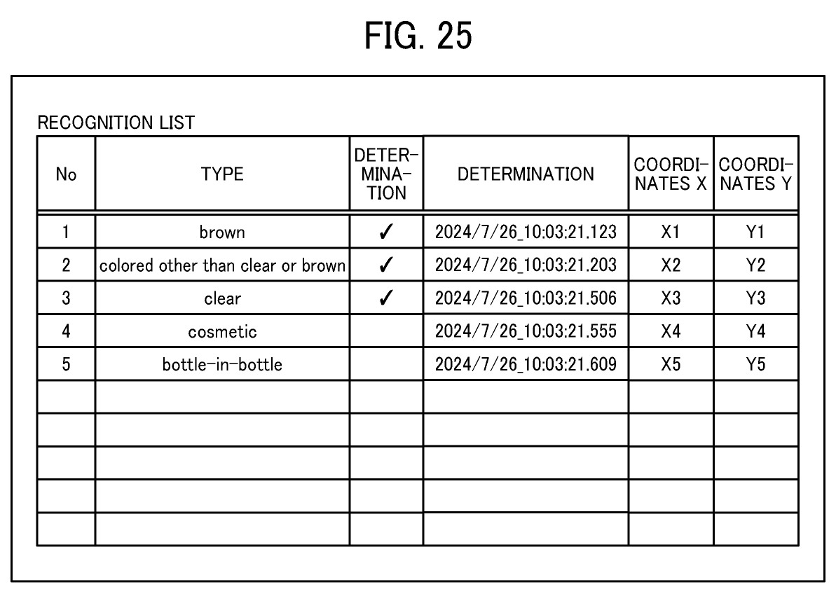

FIG. 16 is a flowchart of an example of an operational flow of the classification device 10 according to the first embodiment. FIG. 17 is a diagram illustrating instance segmentation used by the classification device 10 according to the first embodiment. FIG. 18 is a diagram illustrating object detection used by the classification device 10 according to the first embodiment. FIG. 19 is a diagram illustrating an example of a bottle group image input to the classification device 10 according to the first embodiment. FIG. 20 is a diagram illustrating an operation of recognizing a contour performed by the classification device 10 according to the first embodiment. FIG. 21 is a diagram illustrating an operation of recognizing a bounding rectangle performed by the classification device 10 according to the first embodiment. FIG. 22 is a diagram illustrating an operation of calculating contour centroid coordinates performed by the classification device 10 according to the first embodiment. FIG. 23 is a diagram illustrating an example display presenting a type classification result from the classification device 10 according to the first embodiment. FIG. 24 is a diagram illustrating an example display presenting a determination result indicating whether a bottle is a foreign object from the classification device 10 according to the first embodiment. FIG. 25 is a diagram illustrating an example display presenting text information indicating a classification result and a determination result from the classification device according to the first embodiment. An operational flow of the classification device 10 according to the present embodiment is described below with reference to FIGS. 16 to 25.

In step S11, the image recognition unit 11A receives a bottle group image of a group of bottles conveyed on the belt conveyor 40 via the external device I/F 507 and recognizes a bottle image of each bottle belonging to the group of bottles from the bottle group image. The bottle group image is captured by the camera 20. FIG. 19 illustrates a bottle group image W21 as an example of the bottle group image received by the image processing unit 11. The bottle group image W21 includes bottle images B21 to B25. The bottle image B21 is an image of a brown bottle, the bottle image B22 is an image of a bottle in a color other than clear and brown (colored bottle other than a clear bottle and brown bottle), the bottle image B23 is an image of a clear bottle, the bottle image B24 is an image of a medicine bottle, and the bottle image B25 is an image of a bottle-in-bottle object. Then, the process proceeds to step S12.

In step S12, the image recognition unit 11A recognizes the bottle contour of each bottle from the bottle image using the trained model A for detecting contours of bottles based on instance segmentation. Recognition of bottle contours by instance segmentation is described below with reference to FIG. 17.

In FIG. 17, when focusing on a bottle image B11 included in a bottle group image W11, the image recognition unit 11A recognizes a bottle contour CO11 from the bottle image B11, using the trained model A for detecting bottle contours based on instance segmentation, after recognizing the bottle image B11 from the bottle group image W11. Further, in FIG. 17, when focusing on bottle images B12 to B14 included in a bottle group image W12, the image recognition unit 11A recognizes bottle contours CO12, CO13, and CO14 from the bottle images B12, B13, and B14, respectively, using the trained model A, after recognizing the bottle images B12 to B14 from the bottle group image W11.

As described above, the trained model A may be a trained model that detects a bounding box for each bottle by object detection instead of instance segmentation. Recognition of bottle contours by object detection is described below with reference to FIG. 18. In FIG. 18, when focusing on the bottle image B11 included in the bottle group image W11, the image recognition unit 11A recognizes a bounding box BB11 for the bottle image B11 from the bottle image B11, using the trained model A based on object detection, after recognizing the bottle image B11 from the bottle group image W11. The image recognition unit 11A further recognizes the bottle contour of the bottle included in the bounding box BB11. Further, in FIG. 18, when focusing on the bottle images B12 to B14 included in the bottle group image W12, the image recognition unit 11A recognizes bounding boxes BB12, BB13, and BB14 for the bottle images B12, B13, and B14 from the bottle images B12, B13, and B14, respectively, using the trained model A based on object detection, after recognizing the bottle images B12 to B14 from the bottle group image W12. The image recognition unit 11A further recognizes the bottle contour of the bottle included in each of the bounding boxes BB12 to BB14.

In the case of the bottle group image W21 illustrated in FIG. 19, the image recognition unit 11A recognizes bottle contours CO21, CO22, CO23, CO24, and CO25, as illustrated in FIG. 20, from the bottle images B21, B22, B23, B24, and B25, respectively, using the trained model A based on instance segmentation or object detection as described above, after recognizing the bottle images B21 to B25 from the bottle group image W21.

Then, the process proceeds to step S13.

In step S13, the image recognition unit 11A recognizes a bottle bounding rectangle that has the minimum area and encloses the recognized bottle contour of the target bottle. In the case of the bottle group image W21 illustrated in FIG. 19, the image recognition unit 11A recognizes bottle bounding rectangles RE21, RE22, RE23, RE24, and RE25, as illustrated in FIG. 21. The bottle bounding rectangles RE21, RE22, RE23, RE24, and RE25 that have the minimum area and enclose the bottle contours CO21, CO22, CO23, CO24, and CO25 in the recognized bottle images B21, B22, B23, B24, and B25, respectively. Then, the process proceeds to step S14.

In step S14, the determination unit 11C calculates the contour centroid coordinates of the region enclosed by the bottle contour of the target bottle recognized by the image recognition unit 11A. After calculating the contour centroid coordinates, the determination unit 11C outputs the calculated contour centroid coordinates to the sorting device control unit 13. Subsequently, the determination unit 11C calculates the rectangle center coordinates of the bottle bounding rectangle of the target bottle recognized by the image recognition unit 11A.

In the case of the bottle group image W21 illustrated in FIG. 19, the determination unit 11C calculates contour centroid coordinates CG21, CG22, CG23, CG24, and CG25 of the regions enclosed by the bottle contours CO21, CO22, CO23, CO24, and CO25, respectively, as illustrated in FIG. 22, after the image recognition unit 11A recognizes the bottle contours CO21 to CO25. The determination unit 11C further calculates the rectangle center coordinates of each of the bottle bounding rectangles RE21 to RE25 recognized by the image recognition unit 11A.

Then, the process proceeds to step S15.

In step S15, the determination unit 11C calculates the aspect ratio value based on the width and height of the bottle bounding rectangle of the target bottle recognized by the image processing unit 11. In the case of the bottle group image W21 illustrated in FIG. 19, the determination unit 11C calculates an aspect ratio value based on the width and height of each of the bottle bounding rectangles RE21 to RE25 recognized by the image processing unit 11. Then, the process proceeds to step S16.

In step S16, the determination unit 11C determines whether the inter-coordinate distance between the contour centroid coordinates and the rectangle center coordinates is less than the threshold TH1. When the inter-coordinate distance is less than the threshold TH1 (step S16: Yes), the process proceeds to step S17. When the inter-coordinate distance is equal to or greater than the threshold TH1 (step S16: No), the process proceeds to step S18.

In step S17, the determination unit 11C further determines whether the calculated aspect ratio value is less than the threshold TH2. When the aspect ratio value is less than the threshold TH2 (step S17: Yes), the process proceeds to step S21. When the aspect ratio value is equal to or greater than the threshold TH2 (step S17: No), the process proceeds to step S18.

The determination is made on the inter-coordinate distance in step S16 and the determination is made on the aspect ratio value in step S17 in the above-described embodiment, but the present disclosure is not limited thereto. For example, step S16 may be skipped and the determination of step S17 may be made.

In step S18, the determination unit 11C determines to use a partial-bottle image of the target bottle as an image for type classification for the target bottle, because the target bottle is determined to have a feature from the neck portion to the mouth portion from the determination indicating that the inter-coordinate distance is equal to or greater than the threshold TH1 (step S16: No) or the determination indicating the aspect ratio value is equal to or greater than the threshold TH2 (step S17: No). Then, the process proceeds to step S19.

In step S19, the extraction unit 11B extracts a bottle image from the bottle group image based on the bottle contour recognized by the image recognition unit 11A, and extracts a partial-bottle image including the vicinity of the mouth portion of the bottle from the bottle image. The extraction method in this case is as described above. Then, the process proceeds to step S20.

In step S20, the classification unit 11D classifies the type of the target bottle using the trained model C. Specifically, the classification unit 11D inputs the partial-bottle image of the target bottle to the trained model C after the determination unit 11C determines to use a partial-bottle image as an image for type classification. Then, the type of the target bottle present in the partial-bottle image is classified using the trained model C, and the classification unit 11D obtains the type of the target bottle. Then, the process proceeds to step S23.

In step S21, the determination unit 11C determines to use a whole-bottle image of the target bottle as an image for type classification for the target bottle, because it is determined that the target bottle is likely to have a cylindrical shape without a neck portion and a shoulder portion and classification using the whole bottle is more accurate than using a partial bottle, from the determination indicating that the inter-coordinate distance is less than the threshold TH1 (step S16: Yes) and the determination indicating the aspect ratio value is less than the threshold TH2 (step S17: Yes). The extraction unit 11B extracts a bottle image (whole-bottle image) from the bottle group image based on the bottle contour recognized by the image recognition unit 11A. Then, the process proceeds to step S22.

In step S22, the classification unit 11D classifies the type of the target bottle using the trained model B. Specifically, the classification unit 11D inputs the whole-bottle image of the target bottle to the trained model B after the determination unit 11C determines to use a whole-bottle image as an image for type classification. Then, the type of the target bottle present in the whole-bottle image is classified using the trained model B, and the classification unit 11D obtains the type of the target bottle. Then, the process proceeds to step S23.

In the above-described steps S20 and S22, the display control unit 14 causes the display 508 to display the classification result from the classification unit 11D. In the case of the bottle group image W21 illustrated in FIG. 19, the display control unit 14 displays type-display components KD21, KD22, KD23, KD24, and KD25 superimposed on the bottle group images W21, as illustrated in FIG. 23. Each of the type-display components KD21, KD22, KD23, KD24, and KD25 is a classification result for the bottle present in one of the bottle images B21, B22, B23, B24, and B25. The display mode of the classification result illustrated in FIG. 23 is an example, and the classification result may be displayed in other modes.

In step S23, the judgment unit 11E determines whether the target bottle is either a selection target or a foreign object based on the type of the target bottle classified by the classification unit 11D. The judgment unit 11E outputs (reports) the determination result to the sorting device control unit 13 and the display control unit 14.

The display control unit 14 may display the determination result from the judgment unit 11E on the display 508. For example, in the case of the bottle group image W21 illustrated in FIG. 19, the display control unit 14 may display determination result-display components JR24 and JR25 superimposed on the bottle group image W21 as illustrated in FIG. 24. The determination result-display components JR24 and JR25 indicate that the judgment unit 11E determines that the bottles in the bottle images B24 and B25 are determined to be foreign objects. The display mode of the determination result illustrated in FIG. 24, namely, labeling the foreign objects within the bottle group image W21, is an example. For example, bottle images of selection targets may also be labeled within the bottle group image, in addition to labeling bottle images of foreign objects.

Further, in cases where the display control unit 14 displays the classification result from the classification unit 11D or both the classification result from the classification unit 11D and the determination result from the judgment unit 11E, the results from at least one of the classification unit 11D and the judgment unit 11E may be displayed on the display 508 as text information as illustrated in FIG. 25. In FIG. 25, a check mark indicates an acceptable result (selection target). A blank cell indicates a failed or rejected result (foreign object).

Then, the process proceeds to step S24.

In step S24, when the determination result received from the judgment unit 11E indicates that the target bottle is a selection target, the sorting device control unit 13 sets the contour centroid coordinates of the target bottle received from the determination unit 11C to pickup point coordinates that indicate a pickup point at which the sorting section 31 picks up the selection target. The pickup point coordinates set by the sorting device control unit 13 are coordinates in the coordinate system of the bottle group image, that is, the coordinate system of the camera 20. In view of this, the sorting device control unit 13 converts the set pickup point coordinates of the coordinate system of the camera 20 into pickup point coordinates of the coordinate system of the sorting device 30. The sorting device control unit 13 notifies the sorting device 30 of information including the converted pickup point coordinates. In other words, the sorting device control unit 13 reports the determination result to the sorting device 30. The information notified to the sorting device 30 in this case can be regarded as a determination result obtained by the image processing unit 11 (e.g., the judgment unit 11E) and indicating that the target bottle included in the bottle group image is a selection target.

The operation of the classification device 10 is performed through steps S11 to S24 as described above. The processing of steps S12 to S24 is repeated by the number of bottle images recognized from the bottle group image in step S11.

As described above, in the classification device 10 according to the present embodiment, the classification unit 11D determines the type of a target bottle using one or more trained models trained with bottle images of selection targets and foreign objects excluded from selection, and the judgment unit 11E determines whether the target bottle is a foreign object based on the classification result for the target bottle obtained by the classification unit 11D. Specifically, the trained models to be used are the trained model B for classifying the type of the bottle based on the whole-bottle image and the trained model C for classifying the type of the bottle based on the partial-bottle image. The determination unit 11C determines either the whole-bottle image or the partial-bottle image as an image for type classification, which is used for classifying the type of the target bottle. The classification unit 11D classifies the type of the target bottle using either the whole-bottle image or the partial-bottle image based on the determination result from the determination unit 11C. As described above, in addition to a trained model that is trained with bottle images of selection targets, another trained model that is actively trained with bottle images of foreign objects excluded from selection is used. As a result, the accuracy of sorting between sorting objects into selection targets and foreign objects can be increased.

In the classification device 10 according to the present embodiment, the display control unit 14 displays the classification result from the classification unit 11D on the display 508. This allows the user to visually recognize the classification result not only for the bottles as selection targets but also for the bottles as foreign objects.

### Second Embodiment

The sorting system 1 according to a second embodiment is described below, focusing on differences from the sorting system 1 according to the first embodiment. As described above, in the first embodiment, classification for a target bottle is performed by switching between the trained models according to the conditions of the inter-coordinate distance and the aspect ratio value. In the present embodiment, operation of finally classifying the type of the target bottle by combining the classification results obtained from both the trained models for classification without switching the trained models is described. In the present embodiment, the overall configuration of the sorting system 1 and the hardware configuration of the classification device 10 are substantially the same as those described in the first embodiment.

### Operational Flow of Classification Device

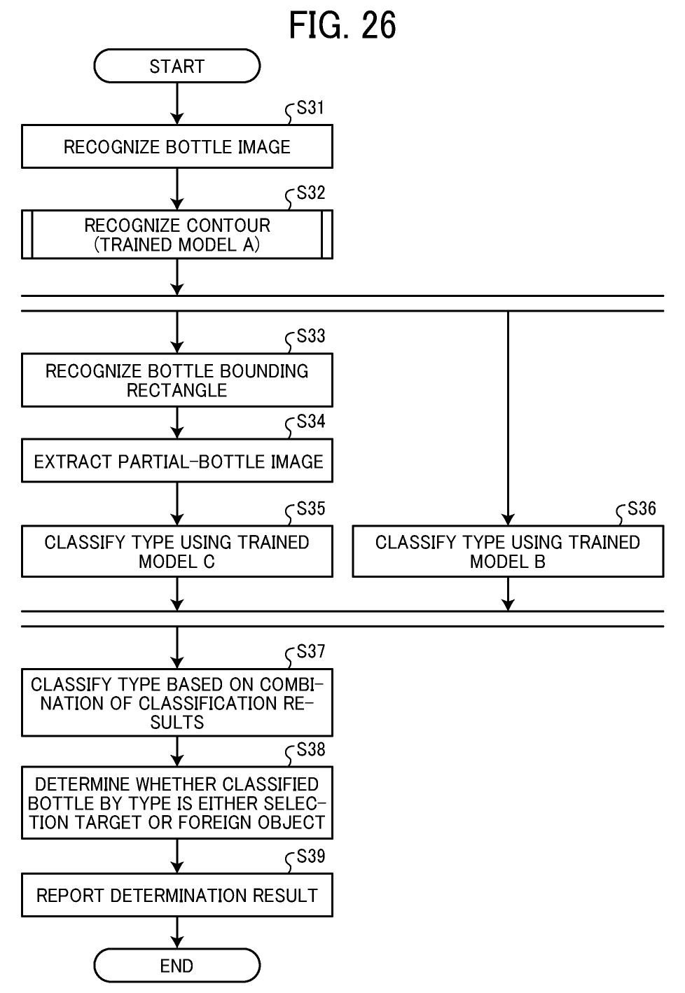

FIG. 26 is a flowchart of an example of an operational flow of the classification device 10 according to the second embodiment. An operational flow of the classification device 10 according to the present embodiment is described below with reference to FIG. 26. The classification device 10 according to the present embodiment does not include the determination unit 11C in the functional configuration illustrated in FIG. 7.

The processing of steps S31 and S32 is substantially the same as that of steps S11 and S12 in FIG. 16. Then, the process proceeds to steps S33 and S36.

In step S33, the image recognition unit 11A recognizes a bottle bounding rectangle that has the minimum area and encloses the recognized bottle contour of the target bottle. Then, the process proceeds to step S34.

In step S34, the extraction unit 11B extracts a bottle image from the bottle group image based on the bottle contour recognized by the image recognition unit 11A, and extracts a partial-bottle image including the vicinity of the mouth portion of the bottle from the bottle image. The extraction method in this case is as described above. Then, the process proceeds to step S35.

In step S35, the classification unit 11D classifies the type of the target bottle using the trained model C. Specifically, the classification unit 11D inputs the partial-bottle image of the target bottle extracted by the extraction unit 11B to the trained model C. Then, the type of the target bottle present in the partial-bottle image is classified using the trained model C, and the classification unit 11D obtains the type of the target bottle.

In step S36, the classification unit 11D classifies the type of the target bottle using the trained model B. Specifically, the classification unit 11D inputs the whole-bottle image of the target bottle extracted by the extraction unit 11B to the trained model B. Then, the type of the target bottle present in the whole-bottle image is classified using the trained model B, and the classification unit 11D obtains the type of the target bottle.

The processing of steps S33 to S35 and the processing of step S36 are executed in parallel. After completing the processing of steps S33 to S35 and the processing of step S36, the process proceeds to step S37.

In step S37, the classification unit 11D combines the classification result output from the trained model B and the classification result output from the trained model C, and finally classifies the type of the target bottle. As assumed methods for the final type classification for the target bottle by the classification unit 11D, there are a method for adopting the classification result with the higher score (credibility) between those obtained from the trained models B and C, a method for adopting only the cases where the classification results from both models B and C coincide and determining the bottle as a foreign object if they do not, and a method for determining the bottle as a foreign object when the classification result output from trained model C is “foreign object” and the score (credibility) is equal to or greater than a threshold. The display control unit 14 causes the display 508 to display the classification result from the classification unit 11D. Then, the process proceeds to step S38.

The processing of steps S38 and S39 is substantially the same as that of steps S23 and S24 in FIG. 16.

The operation of the classification device 10 is performed through steps S31 to S39 as described above. The processing of steps S32 to S39 is repeated by the number of bottle images recognized from the bottle group image in step S31.

As described above, in the classification device 10 according to the present embodiment, the classification unit 11D inputs the whole-bottle image of the target bottle to the trained model B, inputs the partial-bottle image to the trained model C, and classifies the type of the target bottle based on the outputs from the trained model B and the trained model C. As a result, the accuracy of sorting object into selection targets and foreign objects can be increased.

In each of the above-described embodiments, when at least one of the functional units of the classification device 10 is implemented by execution of a program, the program may be preinstalled in a read-only memory (ROM) or any desired memory of the classification device 10. Alternatively, in each of the above-described embodiments, the program executed by the classification device 10 may be stored in a computer-readable recording medium, such as a compact disc-read-only memory (CD-ROM), a flexible disk (FD), a compact disc-recordable (CD-ROM), or a digital versatile disk (DVD) in a file format installable or executable by the computer for distribution. Alternatively, in each of the above-described embodiments, the program executed by the classification device 10 may be stored on a computer connected to a network such as the Internet and provided by being downloaded through the network. Alternatively, in each of the above-described embodiments, the program executed by the classification device 10 may be provided or distributed through a network such as the Internet. In each of the above-described embodiments, the program executed by the classification device 10 has a module configuration including at least one of the above-described functional units. Regarding actual hardware, the CPU 501 reads the program from a memory (such as the ROM 502 or the auxiliary memory 505) and executes the program, thereby loading and generating each of the above-described functional units onto the main memory (ROM 502).

In a waste sorting system, even when the bottles conveyed on a belt conveyor are the same type, empty bottles that previously contained non-food items may be treated differently as foreign objects compared to the bottles that previously contained food or beverages.

The disclosed classification device, classification method, and program can increase the accuracy of sorting objects into selection targets and foreign objects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A classification device, comprising circuitry configured to:
classify a type of a target bottle using a trained model trained with a plurality of bottle images, the plurality of bottle images including a bottle image of a bottle that is a selection target and another bottle image of another bottle that is a foreign object excluded from selection; and
determine whether the target bottle is the foreign object based on a classification result obtained by classifying the type of the target bottle.

2. The classification device of claim 1, wherein
the circuitry is further configured to:
extract a first image being an image of the whole target bottle and a second image being a partial image of the target bottle, from a captured image;
input at least one of the first image or the second image to the trained model; and classify the type of the target bottle based on an output from the trained model.

3. The classification device of claim 2, wherein
the trained model includes a plurality of trained models including a first trained model for bottle type classification using a whole-bottle image and a second trained model for bottle type classification using a partial-bottle image, and
the circuitry is further configured to input the first image and the second image to the first trained model and the second trained model, respectively; and
classify the type of the target bottle based on outputs from the first trained model and the second trained model.

4. The classification device of claim 2, wherein
the trained model includes a plurality of trained models including a first trained model for bottle type classification using a whole-bottle image and a second trained model for bottle type classification using a partial-bottle image, and
the circuitry is further configured to determine one of the first image and the second image to be used as an image for type classification for the target bottle, the image for type classification being input to corresponding one of the first trained model and the second trained model; and
classify the type of the target bottle using the determined one of the first image and the second image.

5. The classification device of claim 4, wherein
the circuitry determines the image for type classification based on an inter-coordinate distance between rectangle center coordinates of a bounding rectangle of the target bottle and contour centroid coordinates of the target bottle on the first image, and an aspect ratio of the bounding rectangle.

6. The classification device of claim 4, wherein,
when the circuitry determines to use the second image as the image for type classification, the circuitry classifies the type of the target bottle using the second image that is an image of the target bottle other than a cylindrical portion of the target bottle in the first image.

7. The classification device of claim 4, wherein,
when the circuitry determines to use the second image as the image for type classification, the circuitry classifies the type of the target bottle using the second image that is a predetermined region in the first image on which upright correction has been performed.

8. The classification device of claim 1, wherein
the circuitry is further configured to display the classification result on a display.

9. The classification device of claim 8, wherein
the circuitry is further configured to display a determination result obtained by determining whether the target bottle is the foreign object on the display.

10. The classification device of claim 1, wherein
the foreign object includes at least one of a non-food and beverage bottle, a content-filled bottle, a bottle-in-bottle object, or a label-covered bottle.

11. The classification device of claim 1, wherein
the circuitry is further configured to notify a sorting device that sorts bottles to select the selection target of a determination result obtained by determining whether the target bottle is the foreign object.

12. A determination method, comprising:
classifying a type of a target bottle using one or more trained models trained with a plurality of bottle images, the plurality of bottle images including a bottle image of a bottle that is a selection target and another bottle image of another bottle that is a foreign object excluded from selection; and
determining whether the target bottle is the foreign object based on a classification result obtained by classifying the type of the target bottle.

13. A computer-readable, non-transitory medium storing a computer program which, when executed by one or more processors, causing the one or more processors to execute a process, the process comprising:
classifying a type of a target bottle using one or more trained models trained with a plurality of bottle images, the plurality of bottle images including a bottle image of a bottle that is a selection target and another bottle image of another bottle that is a foreign object excluded from selection; and
determining whether the target bottle is the foreign object based on a classification result obtained by classifying the type of the target bottle.
